(19) United States
(12) Patent Application Publication
(10) Pub. No.: US 2020/0403562 A1
(43) Pub. Date: Dec. 24, 2020

(54) WATERPROOF ASSEMBLY STRUCTURE FOR SOLAR PANELS

(71) Applicants: Chen Lu Wang, Douliu City (TW); Chao Kai Wang, Douliu City (TW)

(72) Inventors: Chen Lu Wang, Douliu City (TW); Chao Kai Wang, Douliu City (TW)

(21) Appl. No.: 16/862,369

(22) Filed: Apr. 29, 2020

(30) Foreign Application Priority Data
Jun. 21, 2019 (TW) 108121619

(51) Int. Cl. H02S 30/10; H02S 20/20; H01G 9/20

(52) U.S. Cl. CPC H02S 30/10; H01G 9/2077; H02S 20/20

(57) ABSTRACT

A waterproof assembly structure for solar panels arranged in rows and columns with a plurality of longitudinal intervals and lateral intervals therebetween includes a plurality of fastening frames disposed at the longitudinal intervals for fastening the solar panels and a plurality of waterproof frames disposed at the lateral intervals for waterproofing. Each of the waterproof frames includes a cover plate abutting against the solar panels for covering the lateral interval, an extending block provided on the cover plate passing through the lateral interval and a waterproof gasket disposed between the cover plate and the solar panels. A pulling member is connected to the extending block for forcing the cover plate to abut against the solar panels firmly by pulling the extending block.

### BACKGROUND OF THE INVENTION

### Technical Field

The present invention relates to a support frame, and more particularly to a support frame for assembling solar panels.

### Description of Related Art

Solar panels generate electricity by absorbing solar energy and therefore are put outdoors. However, it is hard to avoid getting wet in the rain. Solar panels and support frames thereof are made of metals so as to easily get rusted by acid rain where impurities in the air adhere. After the solar panels and the support frames get rusted, rainwater will invade the gaps between the solar panels and the support frames to cause electricity leakage and short circuit, damaging the solar panels. Therefore, it is necessary to fill up the gaps with glues for waterproofing.

However, some gaps are too small and thin to be found. It is hard to fill up all the gaps so that rainwater will still invade. If a systematized structure taking both assembling and waterproofing into consideration is provided, the aforementioned problem will be solved forever.

### SUMMARY OF THE INVENTION

The primary objective of the present invention is to make sure rainwater is stopped while the waterproof assembly structure is assembled with solar panels firmly, avoiding damaging the solar panels.

For achieving the foregoing and other objectives, the present invention provides a waterproof assembly structure for solar panels arranged in rows and columns, wherein the solar panels that in rows have a plurality of longitudinal intervals therebetween, and the solar panels that in columns have a plurality of lateral intervals therebetween. The waterproof assembly structure includes a plurality of fastening frames disposed at the longitudinal intervals for fastening the solar panels and a plurality of waterproof frames disposed at the lateral intervals for waterproofing. Each of the waterproof frames includes a cover plate abutting against the solar panels for covering the lateral interval, an extending block provided on the cover plate passing through the lateral interval and a waterproof gasket disposed between the cover plate and the solar panels. A pulling member is connected to the extending block for forcing the cover plate to abut against the solar panels firmly by pulling the extending block.

In one embodiment, a hole is located below the solar panels on the extending block. The pulling member includes a sunk block provided through the hole and extending under two adjacent solar panels. A plurality of screw holes are disposed on the sunk block for coupling with a plurality of bolts abutting against two adjacent solar panels. The sunk block is moved to pull the extending block by turning the bolts so as to force the cover plate to abut against the solar panels firmly.

In another embodiment, a hole is located below the solar panels on the extending block. The pulling member includes a sunk block provided through the hole and extending under two adjacent solar panels. The sunk block is bent to form an upper section abutting against two adjacent solar panels and a lower section with a first screw hole provided at a first end far from a position where the sunk block is bent. The first screw hole is opposite to one of two adjacent solar panels for coupling with a first bolt abutting against the upper section. The lower section is moved to pull the extending block by turning the first bolt so as to force the cover plate to abut against the solar panels firmly.

Preferably, a second screw hole is provided at a second end close to the position where the sunk block is bent. The second screw hole is opposite to the other of two adjacent solar panels for coupling with a second bolt abutting against the upper section. The lower section is moved to pull the extending block by turning the first bolt and the second bolt so as to force the cover plate to abut against the solar panels firmly.

Preferably, a plurality of insulating gaskets are disposed between the extending block and the solar panels.

In another embodiment, each of the fastening frames includes an upper fastening member and a lower fastening member. The lower fastening member has a top portion with two side portions disposed at two sides of the top portion. Each of the side portions connects with a bottom portion. Each of the side portion includes a first vertical section, a second vertical section and a horizontal section connecting with the first vertical section and the second vertical section. The upper fastening member has a main portion fixed to the top portion of the lower fastening member. Two wing portions separately extend from both sides of the main portion to press the solar panels onto the horizontal section firmly.

Preferably, the second vertical section is not taller than the first vertical section.

Preferably, a plurality of rubber strips for waterproofing and insulating from electricity are provided between the first vertical section and the solar panels, between the upper fastening member and the solar panels and between the horizontal section and the solar panels.

Preferably, a groove for draining and ventilating is disposed at a junction of the horizontal section and the first vertical section.

### BRIEF DESCRIPTION OF THE DRAWINGS

FIG. 1 is a perspective view of a first embodiment of a waterproof assembly structure according to the present invention;

FIG. 2 is an exploded view of the fastening frame of the waterproof assembly structure;

FIG. 3 is a cross sectional view of the fastening frame of the waterproof assembly structure;

FIG. 4 is an exploded view of the waterproof frame of the waterproof assembly structure;

FIG. 5 is a cross sectional view of the waterproof frame of the waterproof assembly structure;

FIG. 6 is a cross sectional view of the waterproof frame of the waterproof assembly structure in a second embodiment; and

FIG. 7 is a cross sectional view of the waterproof frame of the waterproof assembly structure in a third embodiment.

### DETAILED DESCRIPTION OF THE INVENTION

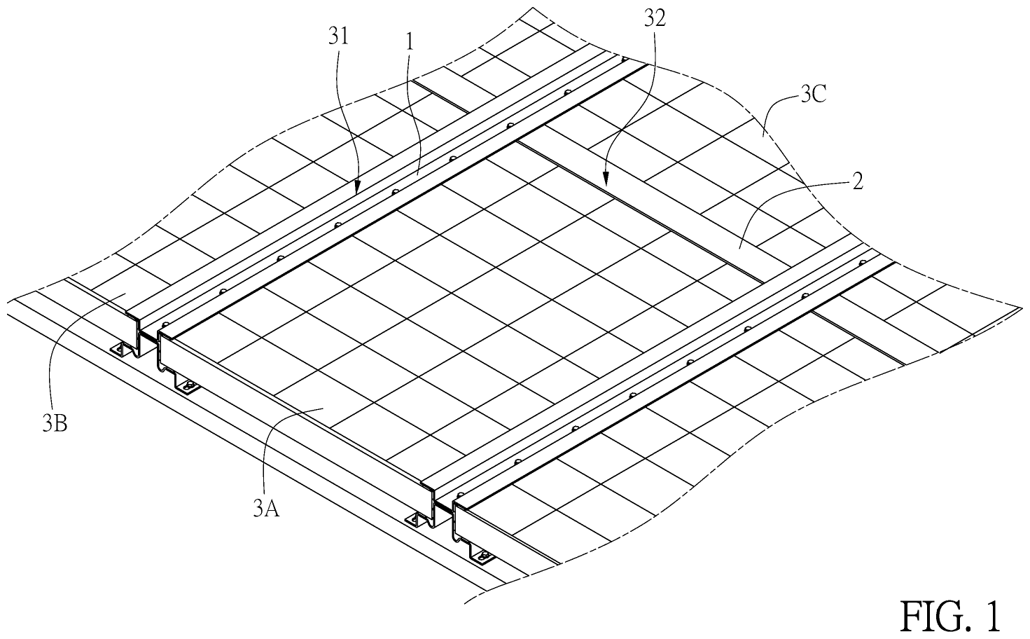

Referring to FIG. 1, solar panels 3A, 3B, 3C are arranged in rows and columns. A plurality of longitudinal intervals 31 are formed between the solar panels 3A, 3B that in rows while a plurality of lateral intervals 32 are formed between the solar panels 3A, 3C that in columns. A waterproof assembly structure for solar panels according to the present invention provides a plurality of fasten frames 1 disposed at the longitudinal intervals 31 for fastening the solar panels 3A, 3B and a plurality of waterproof frames 2 disposed at the lateral intervals 32 for stopping rainwater invading.

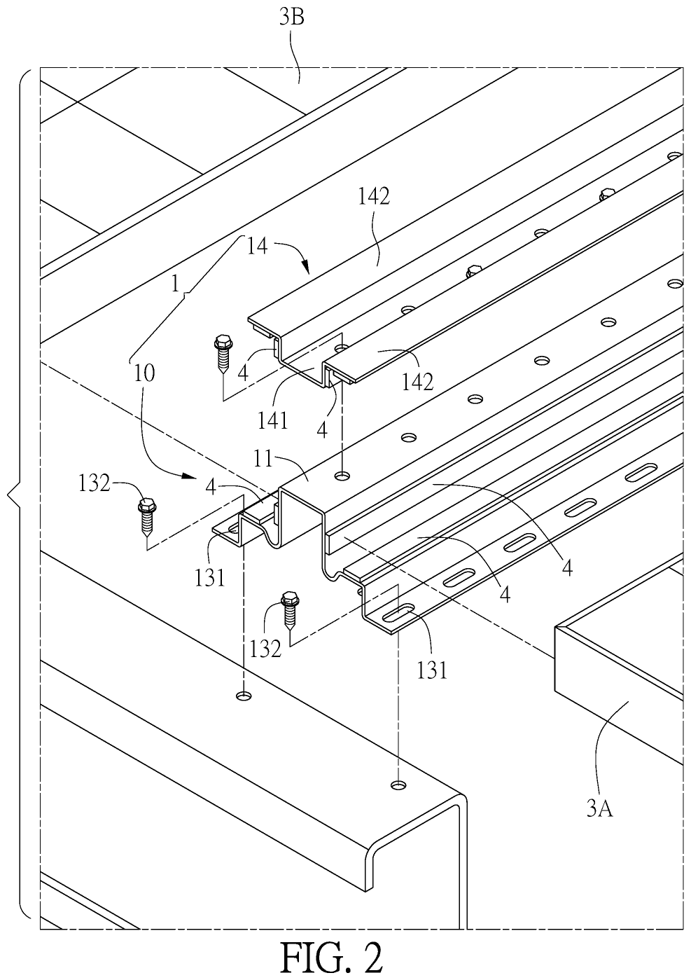

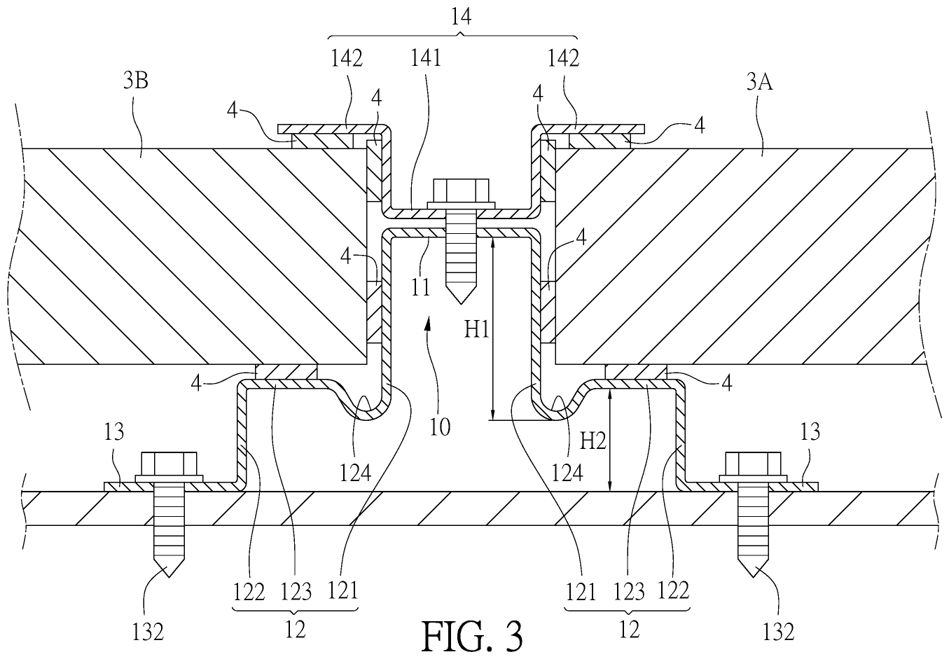

Referring to FIGS. 2 and 3, the aforementioned fasten frame 1 includes an upper fastening member 14 and a lower fastening member 10. The lower fastening member 10 has a top portion 11 raised by two side portions 12 provided at two sides of the top portion 11 along a longitudinal direction. Each of the side portions 12 connects with a bottom portion 13 extending away from each other. A plurality of holes 131 is provided on the bottom portions 13 for screws 132 passing through and fixing the bottom portions 13 with steel structure forming a roof. Each of the side portions 12 includes a first vertical section 121 and a second vertical section 122. The first vertical section 121 connects with the top portion 11. The second vertical section 122 connects with the bottom portion 13. A horizontal section 123 connects the first vertical section 121 and the second vertical section 122. In this embodiment, a height H2 of the second vertical section 122 is not larger than a height H1 of the first vertical section 121. That is, the height H2 of the second vertical section 122 is less than or equal to the height H1 of the first vertical section 121.

Additionally in this embodiment, a long concave groove 124 is provided at a junction of the horizontal section 123 and the first vertical section 121 for purposes of draining and ventilating.

The upper fastening member 14 is fixed on the top portion 11 of the lower fastening member 10. In detail, the upper fastening member 14 has a main portion 141 put above the top portion 11 of the lower fastening member 10 while the main portion 141 is fixed to the top portion 11 with screws. Two wing portions 142 separately extend from both sides of the main portion 141 to be spaced out against the horizontal section 123. Solar panels 3A, 3B are assembled between the wing portion 142 and the horizontal section 123 and are pressed onto the horizontal section 123 firmly by the wing portion 142.

In this embodiment, a plurality of rubber strips 4 for waterproofing and electricity-insulating are coupled on surfaces of the first vertical sections 121, the horizontal sections 123 and the wing portions 22 facing the solar panels 3A, 3B. Solar panels 3A, 3B abut against the rubber strips 4 firmly to be distant from the lower fastening member 10 and the upper fastening member 14. It can be ensured that the solar panels 3A, 3B perform well, or the solar panels 3A, 3B shall not be short-circuited by the lower fastening member 10 and the upper fastening member 14, due to the electricity-insulating property of the rubber strips 4.

Moreover, the rubber strips 4 can also seal gaps to block water from invading. Therefore solar panels 3A, 3B will not be rusted and the service life can be elongated.

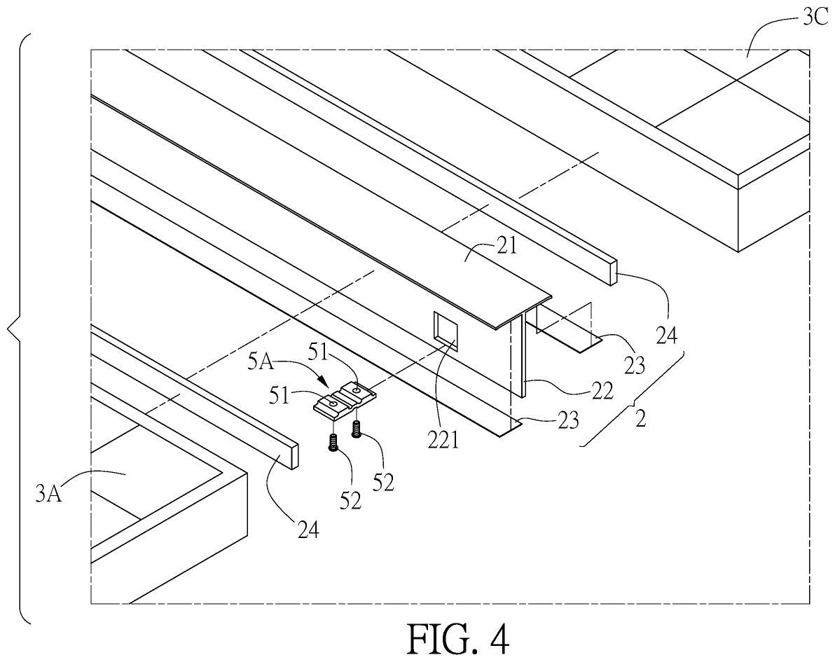

On the other hand, as shown in FIGS. 4 and 5, the waterproof frames 2 includes a cover plate 21 extending laterally with an extending block 22 disposed at the bottom of the cover plate 21. A width of the cover plate 21 is greater than that of the lateral interval 32 so that the cover plate 21 are put on the two adjacent solar panels 3A, 3C to cover the lateral interval 32 completely. A waterproof gasket 23 is disposed between the cover plate 22 and the solar panels 3A, 3C. The extending block 22 passes through the lateral interval 32 with a plurality of insulating gaskets 24 being disposed between the extending block 22 and the solar panels 3A, 3C. A pulling member is connected to the extending block 22 for forcing the cover plate 21 to abut against the solar panels 3A, 3C firmly by pulling the extending block 22 downward. Hence, gaps between the cover plate 21 and the solar panels 3A, 3C are narrowed, with a cooperation of the waterproof gasket 23, to stop rainwater invading.

There are several embodiments for the pulling member. A first embodiment is shown in FIGS. 4 and 5. A hole 221 is formed close to a bottom end of the extending block 22 and is lower than the solar panels 3A, 3C. The pulling member includes a sunk block 5A provided through the hole 221 with two ends extending under the two solar panels 3A, 3C. A plurality of screw holes 51 is disposed in positions opposite to the two solar panels 3A, 3C separately. Each of the screw holes 51 is coupled with a bolt 52 abutting against the bottom of the solar panels 3A or 3C. When turning the bolts 52, the sunk block 5A is moved downward by the function of the thread to pull the extending block 22 downward, and then the cover plate 21 is forced to abut against the solar panels 3A, 3C firmly. Hence, gaps between the cover plate 21 and the solar panels 3A, 3C are narrowed, with a cooperation of the waterproof gasket 23, to stop rainwater invading.

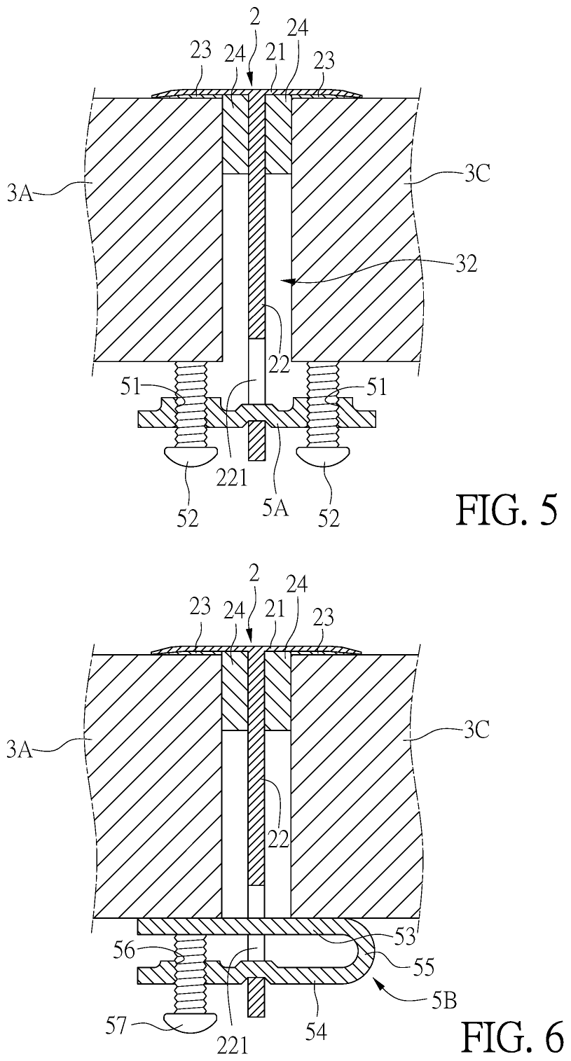

A second embodiment for the pulling member is shown in FIG. 6. In this embodiment, the pulling member includes a sunk block 5B formed in a shape of U which is lying down. The sunk block 5B has an upper section 53 and a lower section 54. The upper section 53 abuts against the bottom of the solar panels 3A, 3C. A first screw hole 56 is disposed at a first end of the lower section 54 far from a position 55 where the sunk block 5B is bent. The first screw hole 56 is opposite to one of the solar panels 3A and is coupled with a first bolt 57 abutting against the upper section 53. When turning the first bolt 57, the lower section 54 is moved downward by the function of the thread to pull the extending block 22 downward, and then the cover plate 21 is forced to abut against the solar panels 3A, 3C firmly. Hence, gaps between the cover plate 21 and the solar panels 3A, 3C are narrowed, with a cooperation of the waterproof gasket 23, to stop rainwater invading.

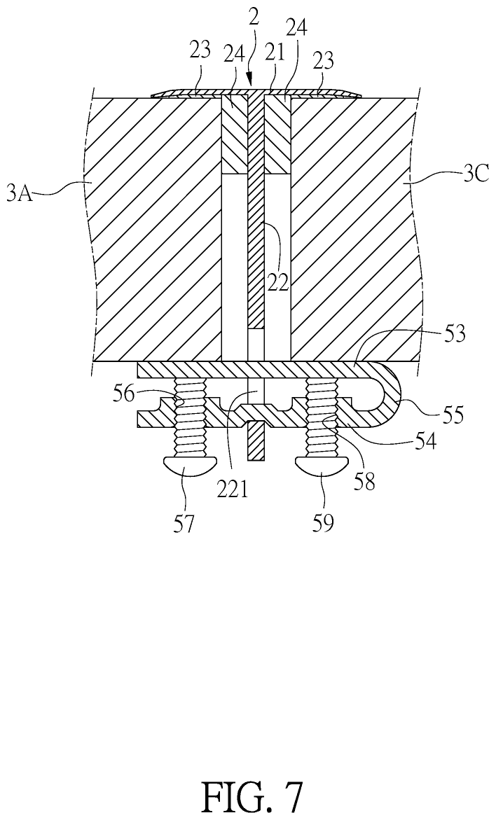

A third embodiment for the pulling member is shown in FIG. 7. Continuing with the structure of the previous embodiment, a second screw hole 58 is disposed at a second end of the lower section 54 close to the position 55 where the sunk block is bent. The second screw hole 58 is opposite to the other of the solar panels 3C and is coupled with a second bolt 59 abutting against the upper section 53. When turning the first bolt 57 and the second bolt 59, the lower section 54 is moved downward by the function of the thread to pull the extending block 22 downward, and then the cover plate 21 is forced to abut against the solar panels 3A, 3C firmly. Hence, gaps between the cover plate 21 and the solar panels 3A, 3C are narrowed, with a cooperation of the waterproof gasket 23, to stop rainwater invading.

What is claimed is:

1. A waterproof assembly structure for solar panels arranged in rows and columns, wherein the solar panels that in rows have a plurality of longitudinal intervals therebetween, and the solar panels that in columns have a plurality of lateral intervals therebetween; the waterproof assembly structure comprising:
a plurality of fastening frames disposed at the longitudinal intervals and extending longitudinally for fastening the solar panels;
a plurality of waterproof frames disposed at the lateral intervals and extending laterally, each of the waterproof frames including a cover plate abutting against the solar panels for covering the lateral interval and an extending block provided on the cover plate passing through the lateral interval, wherein a waterproof gasket is disposed between the cover plate and the solar panels; a pulling member is connected to the extending block for forcing the cover plate to abut against the solar panels firmly by pulling the extending block.

2. The waterproof assembly structure as claimed in claim 1, wherein a hole is located below the solar panels on the extending block; the pulling member includes a sunk block provided through the hole and extending under two adjacent said solar panels, a plurality of screw holes are disposed on the sunk block for coupling with a plurality of bolts abutting against two adjacent said solar panels, whereby the sunk block is moved to pull the extending block by turning the bolts so as to force the cover plate to abut against the solar panels firmly.

3. The waterproof assembly structure as claimed in claim 1, wherein a hole is located below the solar panels on the extending block; the pulling member includes a sunk block provided through the hole and extending under two adjacent said solar panels, the sunk block is bent to form an upper section abutting against two adjacent said solar panels and a lower section with a first screw hole provided at a first end far from a position where the sunk block is bent, the first screw hole is opposite to one of two adjacent said solar panels for coupling with a first bolt abutting against the upper section, whereby the lower section is moved to pull the extending block by turning the first bolt so as to force the cover plate to abut against the solar panels firmly.

4. The waterproof assembly structure as claimed in claim 3, wherein a second screw hole is provided at a second end close to the position where the sunk block is bent, the second screw hole is opposite to the other of two adjacent said solar panels for coupling with a second bolt abutting against the upper section, whereby the lower section is moved to pull the extending block by turning the first bolt and the second bolt so as to force the cover plate to abut against the solar panels firmly.

5. The waterproof assembly structure as claimed in claim 1, wherein a plurality of insulating gaskets are disposed between the extending block and the solar panels.

6. The waterproof assembly structure as claimed in claim 1, wherein each of the fastening frames includes an upper fastening member and a lower fastening member, the lower fastening member has a top portion with two side portions disposed at two sides of the top portion, each of the side portions connects with a bottom portion, wherein each of the side portion includes a first vertical section, a second vertical section and a horizontal section connecting with the first vertical section and the second vertical section; the upper fastening member has a main portion fixed to the top portion of the lower fastening member, two wing portions separately extend from both sides of the main portion to press the solar panels onto the horizontal section firmly.

7. The waterproof assembly structure as claimed in claim 6, wherein the second vertical section is not taller than the first vertical section.

8. The waterproof assembly structure as claimed in claim 6, wherein a plurality of rubber strips for waterproofing and insulating from electricity are provided between the first vertical section and the solar panels, between the upper fastening member and the solar panels and between the horizontal section and the solar panels.

9. The waterproof assembly structure as claimed in claim 6, wherein a groove for draining and ventilating is disposed at a junction of the horizontal section and the first vertical section.
